(19) United States
(12) Patent Application Publication
(10) Pub. No.: US 2020/0055525 A1
(43) Pub. Date: Feb. 20, 2020

(54) Fuel consumption-based driving behavior scoring

(71) Applicant: Ford Global Technologies, LLC, Dearborn, MI (US)

(72) Inventors: Xiangrui Zeng, Northville, MI (US); Amit Mohanty, Canton, MI (US)

(73) Assignee: Ford Global Technologies, LLC, Dearborn, MI (US)

(21) Appl. No.: 15/999,385

(22) Filed: Aug. 20, 2018

(51) Int. Cl. B60W 50/14; B60W 40/09

(52) U.S. Cl. CPC B60W 50/14; B60W 40/09; B60W 2540/30; B60W 2510/0638; B60W 2540/10; B60W 2510/1005; B60W 2520/10; B60W 2540/12; B60W 2510/0657

(57) ABSTRACT

This disclosure describes systems, methods, and computer-readable media related to fuel consumption-based driving behavior scoring. Driving data may be obtained during operation of a vehicle. Based on braking data, a braking event during a first time period may be identified, wherein the braking event exceeds a braking threshold. Based on the braking event, first coached driving data may be generated. Based on the first coached driving data, first fuel savings may be determined. Based on acceleration data, an acceleration event during a second time period may be identified, wherein the acceleration event exceeds an acceleration threshold. Based on the acceleration event, second coached driving data may be generated. Based on the second coached driving data, second fuel savings may be determined. Based on the first and second fuel savings, a total fuel savings may be determined, and a driving behavior score may be generated.

### BACKGROUND

There are many costs associated with operation of a vehicle, such as a car or truck. A focus area for cost reduction is reducing fuel consumption. Many factors contribute to the fuel consumption of a vehicle, including various physical properties of the vehicle such as weight, size, aerodynamics, and the engine design. Further factors include the conditions under which the vehicle is operated, such as average trip length, city versus highway driving, road condition, maintenance intervals, and temperature. Driving behavior may also have an impact on a vehicle's fuel efficiency. The same vehicle driven in different ways may exhibit different fuel consumption behaviors.

### BRIEF DESCRIPTION OF THE DRAWINGS

The detailed description is set forth with reference to the accompanying drawings. The use of the same reference numerals indicates similar or identical components or elements; however, different reference numerals may be used as well to indicate components or elements which may be similar or identical. Various embodiments of the disclosure may utilize elements and/or components other than those illustrated in the drawings, and some elements and/or components may not be present in various embodiments. Depending on the context, singular terminology used to describe an element or a component may encompass a plural number of such elements or components and vice versa.

FIG. 1 depicts an illustrative data flow between various components of an illustrative system architecture for fuel consumption-based driving behavior scoring in accordance with one or more embodiments of the disclosure.

FIGS. 2A-B are block diagrams including various hardware and software components of the illustrative system architecture depicted in FIG. 1 in accordance with one or more embodiments of the disclosure.

FIG. 3 is a process flow diagram of an illustrative method for determining a fuel consumption model for a vehicle for fuel consumption-based driving behavior scoring in accordance with one or more embodiments of the disclosure.

FIG. 4 is a process flow diagram of an illustrative method for shifting behavior coaching for fuel consumption-based driving behavior scoring in accordance with one or more embodiments of the disclosure.

FIG. 5 is a process flow diagram of an illustrative method for acceleration behavior coaching for fuel consumption-based driving behavior scoring in accordance with one or more embodiments of the disclosure.

FIG. 6 is a process flow diagram of an illustrative method for braking behavior coaching for fuel consumption-based driving behavior scoring in accordance with one or more embodiments of the disclosure.

FIG. 7 is a process flow diagram of an illustrative method for fuel consumption-based driving behavior scoring in accordance with one or more embodiments of the disclosure.

### DETAILED DESCRIPTION

This disclosure relates to, among other things, systems, methods, computer-readable media, techniques, and methodology for fuel consumption-based driving behavior scoring. In various embodiments, data regarding the driving behavior of a driver of a vehicle may be collected to determine any driving events that resulted in increased fuel consumption. Improved driving behaviors may be determined and suggested by a driving behavior coaching system, and potential fuel savings may be calculated for the improved driving behaviors. A driving behavior score may be calculated based on the ratio of the amount of fuel consumed by the coached driving behavior to the actual fuel consumed during the monitored driving period. In various embodiments, the driving behavior score may be calculated at the trip level, daily level, or for individual drivers, even if one driver drives multiple different vehicles. A driving behavior score may also be determined for each individual driver of a vehicle. In some embodiments, the driving behavior score is independent of other factors that contribute to fuel consumption, such as trip length, road condition, and vehicle type. In various embodiments, the specific behaviors recommended by the driving behavior coaching system may include shifting up between gears earlier (for embodiments that include a manual transmission vehicle) to reduce or limit the amount of time the vehicle is running at increased revolutions per minute (RPM), avoiding harsh acceleration (i.e., avoiding accelerating the vehicle too quickly), and avoiding harsh braking (i.e., avoiding slowing the vehicle down too quickly).

In some embodiments, driving data of a vehicle may be obtained by a driving behavior coach during operation of the vehicle, the driving data including braking data and acceleration data. Based on the braking data, a braking event during a first time period may be identified by a braking coach, wherein the braking event exceeds a braking threshold in some embodiments. Based on the braking event, the braking coach may generate first coached driving data corresponding to a longer braking period. Based on the first coached driving data, a first fuel savings may be determined by the braking coach. Based on the acceleration data, an acceleration event during a second time period may be identified by an acceleration coach, wherein the acceleration event exceeds an acceleration threshold in some embodiments. Based on the acceleration event, the acceleration coach may generate second coached driving data corresponding to a reduced acceleration. Based on the second coached driving data, a second fuel savings may be determined by the acceleration coach. Based on the first fuel savings and the second fuel savings, a total fuel savings may be determined by the acceleration coach. Based on the total fuel savings, a driving behavior score may be generated by the driving behavior coach.

In some embodiments, driving data may be obtained from a manual transmission vehicle during operation of the vehicle. A first gear number, a first engine speed, a first torque, a first vehicle speed, and a first acceleration corresponding to a third time period may be determined from the driving data. Based on a vehicle response model, for a second gear number adjacent to the first gear number, it may be determined whether a torque demand corresponding to the first vehicle speed and the first acceleration can be met within a time after shifting to the second gear. If it was determined that the torque demand corresponding to the first vehicle speed and the first acceleration can be met within the time after shifting to the second gear, a shifting event to the second gear may be determined. A third fuel savings may be determined based on the shifting event to the second gear. Based on the first fuel savings, the second fuel savings, and the third fuel savings, the total fuel savings may be determined.

Various illustrative embodiments have been discussed above. These and other example embodiments of the disclosure will be described in more detail hereinafter through reference to the accompanying drawings. The drawings and the corresponding description are provided merely for illustration and are not intended to limit the disclosure in any way. It should be appreciated that numerous other embodiments, variations, and so forth are within the scope of this disclosure.

### Illustrative Use Cases and System Architecture

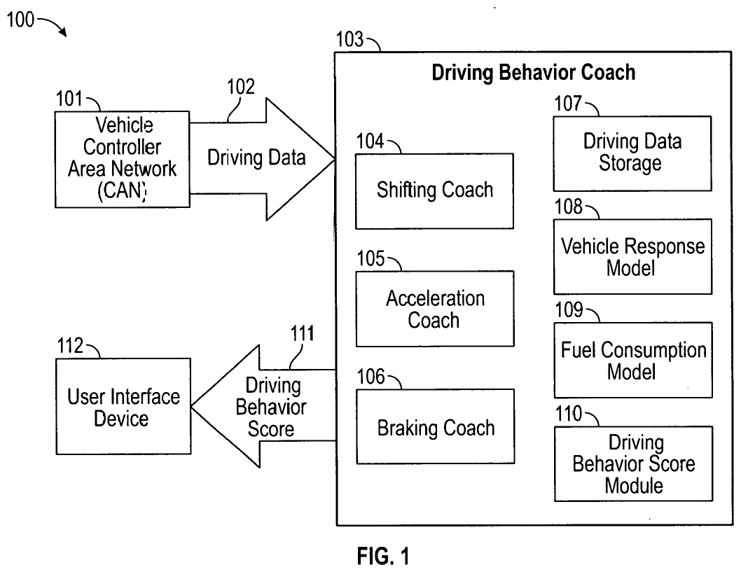

FIG. 1 depicts an illustrative data flow between various components of an illustrative system architecture 100 for fuel consumption-based driving behavior scoring in accordance with one or more embodiments of the disclosure. Vehicle Controller Area Network (CAN) 101, which may be located in any appropriate type of vehicle, including but not limited to a car or truck, provides signals comprising driving data 102 to a driving behavior coach 103 during operation of the vehicle in which the CAN 101 is located. The driving data 102 may include, but is not limited to, fuel consumption data, powertrain data, the current speed of the vehicle, current acceleration of the vehicle, current gear of the transmission of the vehicle (for embodiments in which the vehicle is a manual transmission vehicle), the current torque demand of the vehicle, and the current brake demand of the vehicle. The fuel consumption data included in driving data 102 may include, but is not limited to, the current fuel consumption of the vehicle, which may be determined based on the current fuel flow rate from a flow meter and/or accumulated values in an econometer in the vehicle in various embodiments. The powertrain data included in driving data 102 may include, but is not limited to, the current engine speed of the vehicle, and the current torque of the vehicle in various embodiments. The signals that transmit the various driving data 102 from the CAN 101 to the driving behavior coach 103 may be 1 Hz or higher in some embodiments. The driving data 102 may include any data that is available on the buses of the vehicle CAN 101 in various embodiments.

Driving behavior coach 103 may be implemented in any suitable processor-driven computing device including, but not limited to, one or more computing devices onboard the vehicle (e.g., an engine control unit (ECU) or the like), a laptop computing device, a tablet device, a desktop computing device, a smartphone or other cellular device, a gaming console, a multimedia content streaming device, a set-top box, and so forth. Embodiments of the driving behavior coach 103 may include a shifting coach 104, an acceleration coach 105, a braking coach 106, vehicle data storage 107, a vehicle response model 108, a fuel consumption model 109, and a driving behavior score module 110. The driving data 102 received by driving behavior coach 103 from CAN 101 may be stored in vehicle data storage 107. The shifting coach 104, acceleration coach 105, and braking coach 106 may determine, based on the data in the vehicle data storage 107, any time periods during operation of the vehicle that exhibit inefficient driving behavior based on, for example, comparing the driving data to various predetermined thresholds (e.g., determining that the driver did not shift gears soon enough, determining that the driver performed a relatively fast acceleration, and/or determining that the driver decelerated too quickly). The shifting coach 104, acceleration coach 105, and braking coach 106 may generate coached driving data corresponding to more efficient driving behavior, so as to determine potential fuel savings if the vehicle is operated, in the more efficient manner. Embodiments of shifting coach 104, acceleration coach 105, and braking coach 106 are discussed in further detail below with respect to FIGS. 4, 5, and 6, respectively. In some embodiments, the driving data in driving data storage 107 may be processed by shifting coach 104, acceleration coach 105, and braking coach 106 in a batch manner, over, for example, a trip or a day. In embodiments including onboard processing within the vehicle in which the driving data storage 107 may be relatively small, batch processing may be conducted on a relatively short time period, for example, every 15 to 30 seconds.

The vehicle response model 108 may include data regarding the typical performance of the particular vehicle in which the vehicle CAN 101 is located. In some embodiments, the vehicle response model 108 may be a predetermined model provided by the vehicle manufacturer. In other embodiments, the actual operating, conditions of the vehicle may be taken into account in the vehicle response model 108. Various parameters that can affect the energy consumption of the vehicle, including but not limited to the vehicle load, road grade, wind, and/or road friction, may be factored in to the vehicle response model 108 in some embodiments using, for example, the actual vehicle speed trajectory as measured over time.

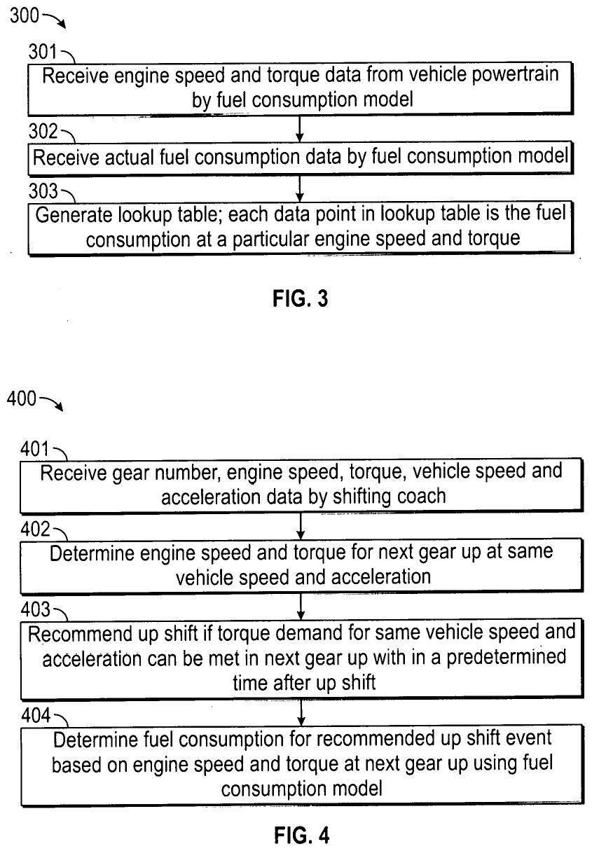

In some embodiments, the fuel consumption model 109 may comprise a two-dimensional lookup table in which data pairs comprising an engine speed value and torque value are associated with respective fuel consumption values. In some embodiments, the fuel consumption model 109 may be provided by the vehicle manufacturer. In other embodiments, the fuel consumption model 109 may be constructed for the particular vehicle based on the driving data 102 that is collected during operation of the vehicle. Embodiments of the fuel consumption model 109 are discussed in further detail below with respect to FIG. 3.

The driving behavior score module 110 may be configured to determine a driving behavior score 111 based on the potential fuel savings determined by the shifting coach 104, the acceleration coach 105, and/or the braking coach 106. The driving behavior score 111 determined by the driving behavior score module 110 may be provided to a user via a user interface device 112. The user interface device 112 may include any suitable processor-driven computing device able to provide and execute user applications and/or transmit and receive information over a network, such as requesting and receiving webpages. The user interface device 112 may include any suitable processor-driven computing device including, but not limited to, a laptop computing device, a tablet device, a desktop computing device, a smartphone or other cellular device, a gaming console, a multimedia content streaming device, a set-top box, and so forth. In some embodiments, the user interface device 112 may be an onboard display in the vehicle. For ease of explanation, the user interface device 112 may be described herein in the singular; however, it should be appreciated that multiple user interface devices 112 may be provided. In some embodiments, the driving behavior score module 110 may also calculate a prediction confidence interval for the driving behavior score, and the driving behavior score 111 may be provided to the user interface device 112 based on the prediction confidence interval being higher than a predetermined confidence threshold. In some embodiments, the user may be a fleet manager who monitors multiple vehicles, and the driving behavior score module 110 may generate respective driving behavior scores for multiple individual drivers of the fleet vehicles. In some embodiments, the driving behavior coach 103 may be implemented within a single vehicle, and the user may be the driver of the vehicle.

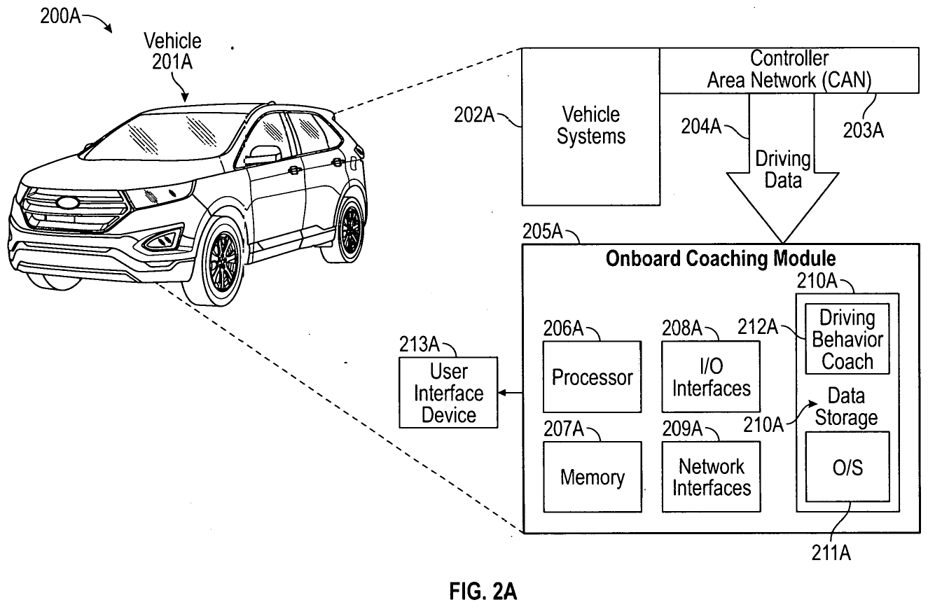

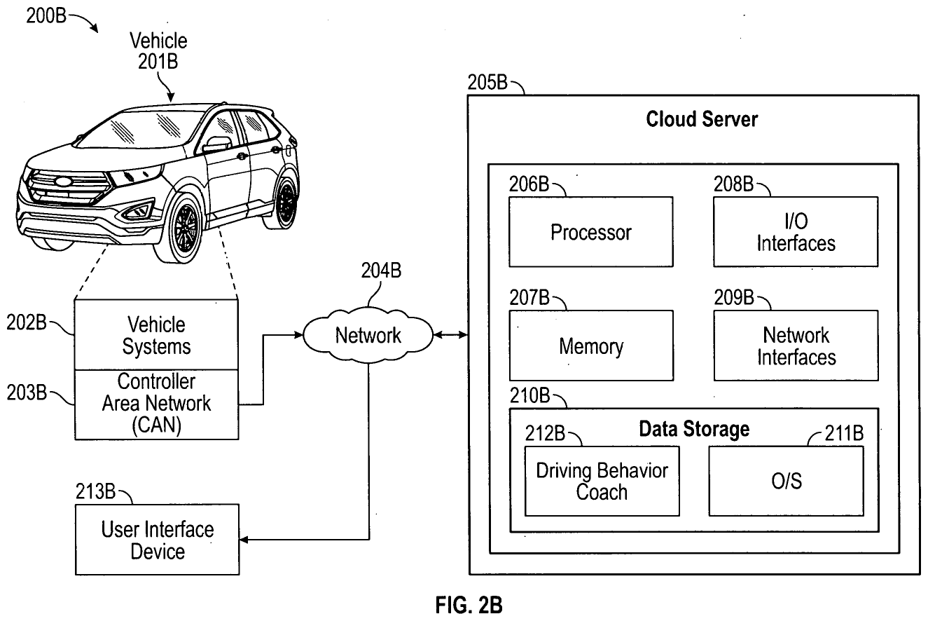

FIGS. 2A and 2B are block diagrams including various hardware and software components of the illustrative system architecture depicted in FIG. 1 in accordance with one or more embodiments of the disclosure. Embodiments of a system architecture 200A that are illustrated by FIG. 2A are implemented within a vehicle 201A. Embodiments of a system architecture 200B that are illustrated by FIG. 2B are implemented externally to a vehicle 201B.

In FIG. 2A, the vehicle 201A includes vehicle systems 202A. The vehicle 201A may be any appropriate type of vehicle, including but not limited to a car or truck. The vehicle systems 202A may include any vehicle systems, including but not limited to transmission, braking, engine, powertrain, and/or fuel systems. The driving data 204A from the various vehicle systems 202A may be received by the onboard coaching module 205A in the vehicle 201A via connections to the buses of the CAN 203A.

The onboard coaching module 205A may include one or more processor(s) 206A and one or more memories 207A (referred to herein generically as memory 207A). The processor(s) 206A may include any suitable processing unit capable of accepting data as input, processing the input data based on stored computer-executable instructions, and generating output data. The computer-executable instructions may be stored, for example, in the data storage 210A and may include, among other things, operating system software and application software. The computer-executable instructions may be retrieved from the data storage 210A and loaded into the memory 207A as needed for execution. The processor(s) 206A may be configured to execute the computer-executable instructions to cause various operations to be performed. The processor(s) 206A may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 210A may store program instructions that are loadable and executable by the processor(s) 206A, as well as data manipulated and generated by the processor(s) 206A during execution of the program instructions. The program instructions may be loaded into the memory 207A as needed for execution. Depending on the configuration and implementation of the onboard coaching module 205A, the memory 207A may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 207A may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

The onboard coaching module 205A may further include additional data storage 210A such as removable storage and/or non-removable storage including, but not limited to, magnetic storage, optical disk storage, and/or tape storage. The data storage 210A may provide non-volatile storage of computer-executable instructions and other data. The memory 207A and/or the data storage 210A, removable and/or non-removable, are examples of computer-readable storage media (CRSM).

The onboard coaching module 205A may further include network interface(s) 209A that facilitate communication between the onboard coaching module 205A and other devices of the illustrative system architecture 200A (e.g., user interface device 213A or CAN 203A). The onboard coaching module 205A may additionally include one or more input/output (I/O) interfaces 208A (and optionally associated software components such as device drivers) that may support interaction between a user and a variety of I/O devices, such as a keyboard, a mouse, a pen, a pointing device, a voice input device, a touch input device, a display, speakers, a camera, a microphone, a printer, and so forth.

Referring again to the data storage 210A, various program modules, applications, or the like may be stored therein that may comprise computer-executable instructions that when executed by the processor(s) 206A cause various operations to be performed. The memory 210A may have loaded from the data storage 210A one or more operating systems (O/S) 211A that may provide an interface between other application software (e.g., dedicated applications, a browser application, a web-based application, a distributed client-server application, etc.) executing on the onboard coaching module 205A and the hardware resources of the onboard coaching module 205A. More specifically, the 0/S 211A may include a set of computer-executable instructions for managing the hardware resources of the onboard coaching module 205A and for providing common services to other application programs (e.g., managing memory allocation among various application programs). The O/S 211A may include any operating system now known or which may be developed in the future including, but not limited to, any mobile operating system, desktop or laptop operating system, mainframe operating system, or any other proprietary or open-source operating system.

The data storage 210A may additionally include various other program modules that may include computer-executable instructions for supporting a variety of associated functionality. For example, the data storage 210A may include a driving behavior coach 212A.

The driving behavior coach 212A, which corresponds to driving behavior coach 103 of FIG. 1, may include computer-executable instructions that in response to execution by the processor(s) 206A cause operations to be performed, such as shifting coaching, acceleration coaching, and/or braking coaching to generate a driving behavior score. Within the data storage 210A, one or more modules may be stored. As used herein, the term module may refer to a functional collection of instructions that may be executed by the one or more processor(s) 206A. For ease of description, and not by way of limitation, separate modules are described. However, it is understood that in some implementations the various functions provided by the modules may be merged, separated, and so forth. Furthermore, the modules may intercommunicate or otherwise interact with one another, such that the conditions of one affect the operation of another.

As shown in FIG. 2A, in some embodiments, the user interface device 213A may be located within the vehicle 201A, for example, as an onboard display, or connected to the onboard coaching module 205A via a physical, wired connection. In some embodiments, the user interface device 213A may be distinct from, or external to, the vehicle 201A, and may be connected to the onboard coaching module 205A by, for example, a Bluetooth, cellular or wireless connection. The user interface device 213A may include any suitable processor-driven computing device able to provide and execute user applications and/or transmit and receive information over a network, such as requesting and receiving webpages. The user interface device 213A may include any suitable processor-driven computing device including, but not limited to, a computing device on board the vehicle, a laptop computing device; a tablet device, a desktop computing device, smartphone or other cellular device, a gaming console, a multimedia content streaming device, a set-top box, and so forth. For ease of explanation, the user interface device 213A may be described herein in the singular; however, it should be appreciated that multiple user interface devices 213A may be provided. The onboard coaching module 205A may provide the driving behavior score generated by driving behavior coach 212A to the user interface device 213A in any appropriate manner.

Turning now to FIG. 2B, the vehicle 201B includes vehicle systems 202B. The vehicle 201B may be any appropriate type of vehicle, including but not limited to a car or truck. The vehicle systems 202B may include any vehicle systems, including but not limited to transmission, braking, engine, powertrain, and fuel systems. Driving data from the various vehicle systems 202B may be received by the cloud server 205B via the CAN 203B and the network 204B.

The cloud server 205B may include one or more processor(s) 206B and one or more memories 207B (referred to herein generically as memory 207B). The processor(s) 206B may include any suitable processing unit capable of accepting data as input, processing the input data based on stored computer-executable instructions, and generating output data. The computer-executable instructions may be stored, for example, in the data storage 210B and may include, among other things, operating system software and application software. The computer-executable instructions may be retrieved from the data storage 210B and loaded into the memory 207B as needed for execution. The processor(s) 206B may be configured to execute the computer-executable instructions to cause various operations to be performed. The processor(s) 206B may include any type of processing unit including, but not limited to, a central processing unit, a microprocessor, a microcontroller, a Reduced Instruction Set Computer (RISC) microprocessor, a Complex Instruction Set Computer (CISC) microprocessor, an Application Specific Integrated Circuit (ASIC), a System-on-a-Chip (SoC), a field-programmable gate array (FPGA), and so forth.

The data storage 210B may store program instructions that are loadable and executable by the processor(s) 206B, as well as data manipulated and generated by the processor(s) 206B during execution of the program instructions. The program instructions may be loaded into the memory 207B as needed for execution. Depending on the configuration and implementation of the cloud server 205B, the memory 207B may be volatile memory (memory that is not configured to retain stored information when not supplied with power) such as random access memory (RAM) and/or non-volatile memory (memory that is configured to retain stored information even when not supplied with power) such as read-only memory (ROM), flash memory, and so forth. In various implementations, the memory 207B may include multiple different types of memory, such as various forms of static random access memory (SRAM), various forms of dynamic random access memory (DRAM), unalterable ROM, and/or writeable variants of ROM such as electrically erasable programmable read-only memory (EEPROM), flash memory, and so forth.

The cloud server 205B may further include additional data storage 210B such as removable storage and/or non-removable storage including, but not limited to, magnetic storage, optical disk storage, and/or tape storage. Data storage 210B may provide non-volatile storage of computer-executable instructions and other data. The memory 207B and/or the data storage 210B, removable and/or non-removable, are examples of computer-readable storage media (CRSM).

The cloud server 205B may further include network interface(s) 209B that facilitate communication between the cloud server 205B and other devices of the illustrative system architecture 200A (e.g., user interface device 213B or CAN 203B). The cloud server 205B may additionally include one or more input/output (I/O) interfaces 208B (and optionally associated software components such as device drivers) that may support interaction between a user and a variety of I/O devices, such as a keyboard, a mouse, a pen, a pointing device, a voice input device, a touch input device, a display, speakers, a camera, a microphone, a printer, and so forth.

Referring again to the data storage 210B, various program modules, applications, or the like may be stored therein that may comprise computer-executable instructions that when executed by the processor(s) 206B cause various operations to be performed. The memory 210B may have loaded from the data storage 210B one or more operating systems (O/S) 211B that may provide an interface between other application software (e.g., dedicated applications, a browser application, a web-based application, a distributed client-server application, etc.) executing on the cloud server 205B and the hardware resources of the cloud server 205B. More specifically, the 0/S 211B may include a set of computer-executable instructions for managing the hardware resources of the cloud server 205B and for providing common services to other application programs (e.g., managing memory allocation among various application programs). The O/S 211B may include any operating system now known or which may be developed in the future including, but not limited to, any mobile operating system, desktop or laptop operating system, mainframe operating system, or any other proprietary or open-source operating system.

The data storage 210B may additionally include various other program modules that may include computer-executable instructions for supporting a variety of associated functionality. For example, the data storage 210B may include a driving behavior coach 212B.

The driving behavior coach 212B, which corresponds to driving behavior coach 103 of FIG. 1, may include computer-executable instructions that in response to execution by the processor(s) 206B cause operations to be performed such as shifting coaching, acceleration coaching, and/or braking coaching to generate a driving behavior score. Within the data storage 210B, one or more modules may be stored. As used herein, the term module may refer to a functional collection of instructions that may be executed by the one or more processor(s) 206B. For ease of description, and not by way of limitation, separate modules are described. However, it is understood that in some implementations the various functions provided by the modules may be merged, separated, and so forth. Furthermore, the modules may intercommunicate or otherwise interact with one another, such that the conditions of one affect the operation of another.

Any of the CAN 203B in the vehicle 201B, the cloud server 205B, and the user interface device 213B may be configured to communicate with each other and any other component of the system architecture 200B via one or more network(s) 204B. The network(s) 204B may include, but are not limited to, any one or a combination of different types of suitable communications networks such as, for example, cable networks, public networks (e.g., the Internet), private networks, wireless networks, cellular networks, or any other suitable private and/or public networks. Further, the network(s) 204B may have any suitable communication range associated therewith and may include, for example, global networks (e.g., the Internet), metropolitan area networks (MANs), wide area networks (WANs), local area networks (LANs), or personal area networks (PANs). In addition, the network(s) 204B may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof.

As shown in FIG. 2B, in some embodiments, the user interface device 213B may be external to the vehicle 201B, and communicate with cloud server 205B via network 204B. The user interface device 213B may include any suitable processor-driven computing device able to provide and execute user applications and/or transmit and receive information over a network, such as requesting and receiving webpages. The user interface device 213B may include any suitable processor-driven computing device including, but not limited to, a laptop computing device, a tablet device, a desktop computing device, smartphone or other cellular device, a gaming console, a multimedia content streaming device, a set-top box, and so forth. For ease of explanation, the user interface device 213B may be described herein in the singular; however, it should be appreciated that user interface device 213B may be provided. The cloud server 205B may provide the driving behavior score generated by driving behavior coach 213B to the user interface device 213B in any appropriate manner.

Those of ordinary skill in the art will appreciate that any of the components of the system architectures 200A-B may include alternate and/or additional hardware, software, or firmware components beyond those described or depicted without departing from the scope of the disclosure. More particularly, it should be appreciated that hardware, software, or firmware components depicted or described as forming part of any of the illustrative components of the system architectures 200A-B, and the associated functionality that such components support, are merely illustrative and that some components may not be present or additional components may be provided in various embodiments. While various program modules have been depicted and described with respect to various illustrative components of the system architectures 200A-B, it should be appreciated that the functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of hardware, software, and/or firmware for implementing the functionality. Accordingly, it should be appreciated that the functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Further, while certain modules may be depicted and described as sub-modules of another module, in certain embodiments, such modules may be provided as independent modules.

Those of ordinary skill in the art will appreciate that the illustrative system architectures 200A-B are provided by way of example only. Numerous other operating environments, system architectures, and device configurations are within the scope of this disclosure. Other embodiments of the disclosure may include fewer or greater numbers of components and/or devices and may incorporate some or all of the functionality described with respect to the illustrative system architectures 200A-B, or additional functionality.

### ILLUSTRATIVE PROCESSES

FIG. 3 is a process flow diagram of an illustrative method 300 for constructing a fuel consumption model for a vehicle for embodiments of fuel consumption-based driving behavior scoring in accordance with one or more embodiments of the disclosure. Method 300 may be implemented with respect to fuel consumption model 109 in driving behavior coach 103 of FIG. 1. In block 301, the fuel consumption model 109 receives engine speed and torque data from the vehicle powertrain via CAN 101 during operation of the vehicle. In some embodiments, the engine speed and torque signals may be 1 Hz or higher in frequency. In block 302, the fuel consumption model 109 receives actual vehicle fuel consumption data from CAN 101 during operation of the vehicle. The fuel consumption data may be received from a flow meter, or may be an accumulated value from an econometer in various embodiments. In some embodiments, fuel consumption data signal may be 1 Hz or higher in frequency. Each fuel consumption value corresponds to a particular pair of engine speed and torque values. In block 303, the fuel consumption model generates a fuel consumption lookup table based on the engine speed, torque, and fuel consumption data that was collected in blocks 301 and 302. Embodiments of a fuel consumption lookup table may include a two-dimensional lookup table in which the associated fuel consumption is given for each pair of received engine speed and torque values. In some embodiments, the fuel consumption lookup table may be generated using linear regression. The fuel consumption during a time period is considered a measurement, and the time the engine spent at each torque-speed grid point is considered a feature. The number of features is the number of grid points in the fuel consumption lookup table. This regression problem can be solved via stochastic gradient descent in some embodiments.

In some embodiments, fitting the fuel consumption model 109 to the particular vehicle as described in FIG. 3 may not be performed because a steady-state engine fuel consumption model for a vehicle may be constructed via experiment on a test engine for the vehicle type, and the constructed model may be obtained from the vehicle manufacturer. However, fitting the fuel consumption model 109 with actual vehicle data obtained during operation of the particular vehicle may result in a statistically more accurate fuel consumption model for the vehicle based on the operating conditions of the vehicle. For example, a vehicle may have a large portion of operation time under cold temperature engine start, or the fuel efficiency of a specific engine may drop significantly due to poor maintenance or aging. In such embodiments, a fitted fuel consumption model 109 generated according to method 300 of FIG. 3 using actual vehicle data may enable relatively accurate fuel savings calculations.

FIG. 4 is a process flow diagram of an illustrative method 400 for shifting behavior coaching for fuel consumption-based driving behavior scoring in accordance with one or more embodiments of the disclosure. Method 400 may be implemented in shifting coach 104 of FIG. 1. In block 401, the shifting coach 104 receives driving data including current gear number, engine speed, torque, vehicle speed, and acceleration data. The driving data may be obtained from driving data storage 107. In block 402, the shifting coach 104 determines the engine speed and torque at a next gear up from the current gear for the same vehicle speed and acceleration based on the vehicle response model 108. In block 403, it is determined whether the torque demand for the same vehicle speed and acceleration can be met in the next gear within a predetermined amount of time after the up shift. If the torque demand can be met within the predetermined amount of time, the up shift to the next gear is recommended by shifting coach 104. If the torque demand cannot be met within the predetermined amount of time, the up shift to the next gear is not recommended by shifting coach 104, so as to avoid frequent shift change, and method 400 ends. In block 404, based on the fuel consumption model 109, the shifting coach 104 determines the fuel consumption at the next gear up for the recommended up shift event.

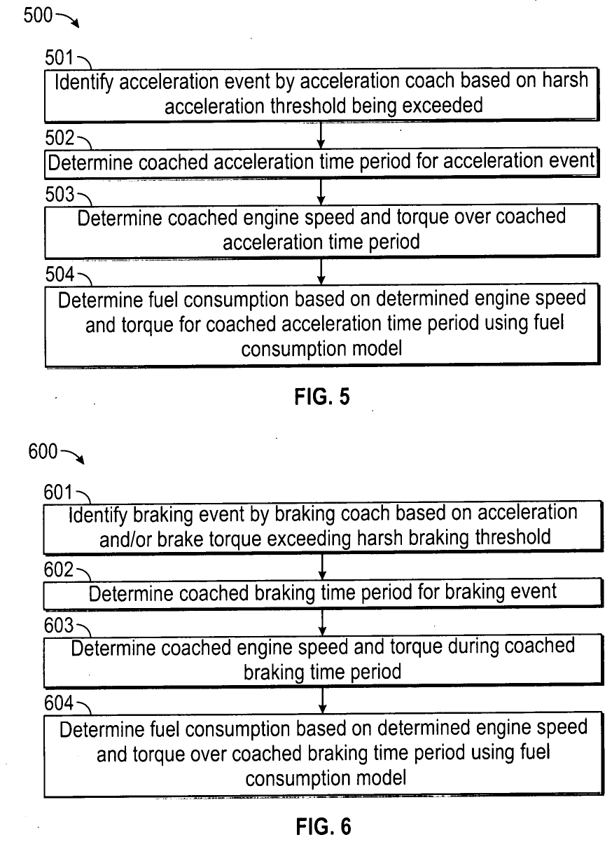

FIG. 5 is a process flow diagram of an illustrative method 500 for acceleration behavior coaching for fuel consumption-based driving behavior scoring in accordance with one or more embodiments of the disclosure. Method 500 may be implemented in acceleration coach 105 of FIG. 1. In block 501, an acceleration event is identified in the driving data from driving data storage 107 by the acceleration coach 105 based on the acceleration of the vehicle exceeding a harsh acceleration threshold. In block 502, a coached acceleration time period is determined for the time period associated with the detected acceleration event by the acceleration coach 105. The coached acceleration time period may be longer or shorter than the actual acceleration time period in various embodiments. In block 503, coached driving data comprising the engine speed and torque are determined for the coached acceleration time period based on the vehicle response model 108. In block 504, fuel consumption based on the coached driving data engine speed and torque over the coached acceleration time period, as calculated in block 503, are determined by the acceleration coach 105 based on the fuel consumption model 109.

In some embodiments, the harsh acceleration threshold may be used to monitor data from an acceleration signal or accelerator pedal to detect harsh acceleration events. In some embodiments, the coached driving data is determined in block 503 to replace the actual driving data over the coached acceleration time period, starting at the beginning position of the acceleration event, and ending at the position of the vehicle a preterminal amount of time (e.g., 3 seconds) after the acceleration event. In such embodiments, the coached driving data will have the same initial speed vᵢ, the same final speed v_{f}, and cover the same distance d, as the actual driving data; however, the amount of time (i.e., the coached acceleration time period) may be different, such that the coached driving behavior may take longer or shorter time for the vehicle to drive through distance d. The constant acceleration a for the coached driving data may be:

a=(v_{f}²−vₜ²)/2d EQ. 1.

Therefore, the coached acceleration time period t of the constant acceleration, as calculated in block 502, may be:

$$t = \frac{{v}_{f} - {v}_{i}}{a} = \frac{2 d}{{v}_{i} + {v}_{f}} . \qquad EQ . 2$$

The coached acceleration time period may be different from the actual time period it took the vehicle to cover the distance d, e.g., the duration of the acceleration event plus 3 seconds.

In some embodiments, the engine speed may be calculated in block 503 assuming that the gear of the vehicle will remain the same over the coached acceleration time period. In some embodiments, the vehicle longitudinal dynamics model m\dot{x} may be described as follows:

m\ddot{x}^{⋅}=Fₚᵣₒₚₑₗₗ−fᵥ(\dot{x})F_{z}−½ρC_{d}A_{f}(\dot{x}+V_{wind})²−mg sin θ(x) EQ. 3,

where x is the distance, \dot{x} is the longitudinal speed, \ddot{x}x is the longitudinal acceleration, m is the vehicle mass, Fₚᵣₒₚₑₗₗ is the equivalent propelling force at the tire from the powertrain, fᵥ(⋅) is the friction coefficient which is related to the speed of the vehicle, F_{z} is the vehicle normal force to the ground, ρ is the air density, C_{d} is the air drag coefficient, A_{F} is the drag area, V_{wind} is the longitudinal wind speed, g is the gravitational acceleration, and θ(⋅) is the road grade which is dependent on the distance of the vehicle traveled.

There are some unknown and changing parameters in EQ. 3 above, and it could be difficult to estimate all of these parameters using production vehicle onboard sensors. However, as the coached driving data may be a relatively small perturbation from the actual driving data in terms of speed and location, and therefore the rolling resistance, air drag, and road grade may be relatively close to the rolling resistance, air drag, and road grade of the actual trip, it may be approximated that:

m\ddot{x}≈Fₚᵣₒₚₑₗₗ−F_{resistance}(x) EQ. 4.

The coached acceleration time period may last a relatively short time, e.g., a few seconds, therefore the resistance may be approximately considered as a constant F̅_{resistance} during the coached acceleration time period. This constant F̅_{resistance} may be calculated using the actual vehicle data and the following relationship:

½mv_{f}²−½mvᵢ²=∫ₜ_{ᵢ}^{t}^{_{f}}T_{eng}ω_{eng}dt−F̅_{resistance}d EQ. 5,

where T_{eng} is the engine torque, and ω_{eng} is the engine speed. Therefore, the calculation of coached driving data engine torque is as follows: first, the resistance force is estimated,

$${\overline{F}}_{resistance} = \frac{2 {\int }_{{t}_{i}}^{{t}_{f}} {T}_{eng} {ω}_{eng} dt - {mv}_{f}^{2} + {mv}_{i}^{2}}{2 d} . \qquad EQ . 6$$

Then the propel torque is:

Fₚᵣₒₚₑᵢₗ=ma+F̅_{resistance} EQ. 7.

The engine torque is:

$${T}_{eng} = \frac{{F}_{propell} r}{{i}_{f} {i}_{g}} , \qquad EQ . 8$$

where r is the wheel radius, i_{f} is the final ratio, and i_{g} is the gear ratio.

In embodiments in which the sampling rate of the driving data signals is relatively low (e.g. 1 Hz), the resolution in time sampling may affect the result accuracy. Therefore, in some embodiments, the acceleration coach 105 may perform the calculations of block 503 in a continuous time domain or interpolated higher-sampling-rate discrete time domain, instead of the original discrete time domain.

FIG. 6 is a process flow diagram of an illustrative method 600 for braking behavior coaching for fuel consumption-based driving behavior scoring in accordance with one or more embodiments of the disclosure. Method 600 may be implemented in braking coach 106 of FIG. 1. In block 601, a braking event is identified by the braking coach 106 based on the acceleration or brake torque in the driving data exceeding a harsh braking threshold. In block 602, a coached braking time period is determined for the braking time period. The coached braking time period may be longer than the actual braking time period in some embodiments. In block 603, coached driving data comprising the engine speed and torque are determined for the coached braking time period based on the vehicle response model 108. In block 604, fuel consumption based on the engine speed and torque for the coached braking time period are determined based on the fuel consumption model 109.

In some embodiments, the coached braking time period may be the actual duration of the braking event plus a predetermined amount of time, for example, 2 seconds. The added predetermined amount of time that is used to determine the coached braking time period in block 602 may be any appropriate amount of time in various embodiments. Before braking, there may be a coasting process, during which the driver does not press the accelerator or the brake pedal. In such embodiments, the braking coach 106 recommends that the vehicle commence coasting 2 seconds earlier than occurred in the actual driving data. Therefore, the coached driving data that is generated in block 603 to replace the actual driving data over the coached braking time period may include 2 seconds before the coasting, plus the coasting time, plus the braking event time. The coached driving data generated in block 603 may have the same initial speed vᵢ, the same final speed v_{f}, and cover the same distance d over the coached braking time period. The deceleration value of the coached driving data in this coached braking time period will be different from the actual driving data. However, for embodiments including an internal combustion engine vehicle without braking energy regeneration feature, it is not necessary to calculate a new braking torque. In this example, the fuel consumption is determined in block 604 based on the engine entering idling 2 seconds earlier than in the actual driving data and staying at idling during the coached braking time period.

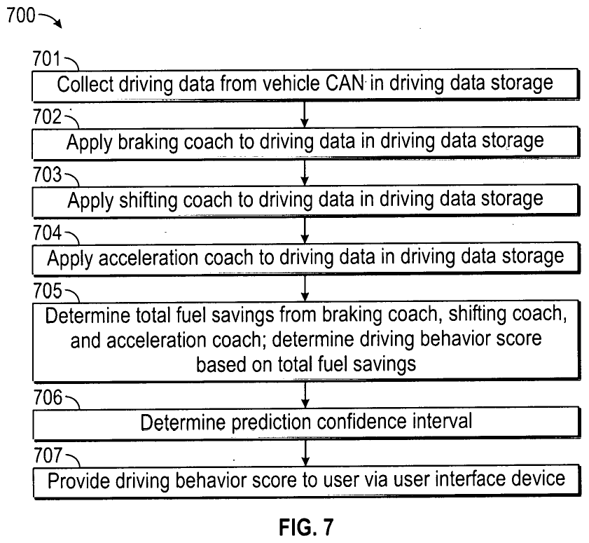

FIG. 7 is a process flow diagram of an illustrative method 700 for fuel consumption-based driving behavior scoring in accordance with one or more embodiments of the disclosure. Method 700 is implemented in driving behavior coach 103 of FIG. 1. In block 701, driving data 102 is received from CAN 101 by driving behavior coach 103, and stored in driving data storage 107. The driving data may include, but is not limited to, fuel consumption data, powertrain data, the current speed of the vehicle, current acceleration of the vehicle, current gear of the transmission of the vehicle (for embodiments in which the vehicle is a manual transmission vehicle), the current torque demand of the vehicle, and the current brake demand of the vehicle. The fuel consumption data included in driving data 102 may include, but is not limited to, the current fuel consumption of the vehicle, which may be determined based on the current fuel flow rate or accumulated values in an econometer in the vehicle. The powertrain data included in driving data 102 may include, but is not limited to, the current engine speed of the vehicle, and the current torque of the vehicle. The signals that transmit the various driving data 102 to the driving behavior coach 103 from the CAN 101 may be 1 Hz or higher in some embodiments, e.g., the values in the driving data are stored in the driving data storage 107 every second over the duration of the operation of the vehicle. The driving data 102 may include any data that is available on the buses of the vehicle CAN 101 in various embodiments.

In some embodiments, the driving data is stored in the driving data storage 107 and is processed as described below with respect to blocks 702-707 in a batch manner. In some embodiments, in which driving data storage 107 comprises a relatively small memory, the processing of blocks 702-707 may be repeated on a relatively short time period, for example, every 15 to 30 seconds, so as to make space in the driving data storage 107 for new driving data. In other embodiments, the driving data in driving data storage 107 may be processed on a per trip or per day basis. In some embodiments, the driving data in driving data storage 107 may be associated with a particular driver, so that the driving behavior coach 103 may generate different driving behavior scores for different drivers of the same vehicle, or generate driving behavior scores for the same driver across different vehicles in a fleet of vehicles.

In block 702, the braking coach 106 is applied to the driving data in driving data storage 107. The braking coach operates as described above with respect to method 600 of FIG. 6. In block 702, the braking coach 106 may identify any number of braking events in the driving data based on the harsh braking threshold, and calculate fuel consumption for the coached driving data that is generated for each identified braking event.

Next, in block 703, the shifting coach 104 is applied to the driving data in the data storage 107. In some embodiments, the shifting coach 104 is applied to the driving data in the driving data storage 107 after the braking coach 106, such that any driving data from time periods that have been processed (i.e., identified as a braking event) by the braking coach 106 is not examined by the shifting coach 104, and no shifting events identified by the shifting coach 104 overlap with any braking events identified by braking coach 106. The shifting coach 104 operates as described above with respect to method 400 of FIG. 4. In block 703, the shifting coach 104 may identify any number of up shift recommendation events in the driving data, and calculate fuel consumption for the coached driving data that is generated for each identified up shift recommendation event.

Next, in block 704, the acceleration coach 105 applied to the driving data in the data storage 107. In some embodiments, the acceleration coach is applied to the driving data in the driving data storage 107 after the braking coach 106 and the shifting coach 104, such that any driving data from time periods that have been processed (i.e., identified as a braking event or an up shift recommendation event) by the braking coach 106 or the shifting coach 104 is not examined by the acceleration coach 105, and no acceleration events identified by the acceleration coach 105 overlap with any braking events identified by braking coach 106 or any shifting events identified by shifting coach 104. The acceleration coach 105 operates as described above with respect to method 500 of FIG. 5. In block 704, the acceleration coach 105 may identify any number of acceleration events in the driving data based on the harsh acceleration threshold, and calculate fuel consumption for the coached driving data that is generated for each identified acceleration event.

In block 705, total fuel savings are determined based on the total coached fuel consumption that was calculated by the braking coach 106, the shifting coach 104, and the acceleration coach 105 in blocks 702-704, and comparing the coached fuel consumption to the actual fuel consumption. The fuel savings may then be used to determine a driving behavior score 111 by the driving behavior score module 110 for a particular driver associated with the processed batch of driving data.

In some embodiments, the ratio between the coached fuel consumption and the actual fuel consumed is X %. i.e., the driver could have used X % of the actual consumed fuel to complete the same trip by driving in a more efficient manner as recommended by the braking coach 106, the shifting coach 104, and the acceleration coach 105. The driving behavior score 111 may be generated based on X. For example, in some embodiments, the driving behavior score may be equal to X. In some embodiments, to widen the range of scores, 2X-100, X\hat{ }2/(100)\hat{ }2 or any other appropriate transformation may be used to generate the driving behavior score 111.

In block 706, in some embodiments, a prediction confidence interval is determined by the driving behavior score module 110. The prediction confidence interval may be determined based on bootstrapping in some embodiments. The fuel consumption and engine data may be resampled with replacement data from the collected powertrain data and fuel consumption data. The total sum of time on all resampled data will be the same as the coached driving data time, allowing the error distribution of the fuel consumption model to be estimated via bootstrapping. With the error distribution known, the prediction confidence interval can be calculated, usually at 90% or 95% level. The prediction confidence interval may be used to determine when to show the driving behavior score to the user. In some embodiments, the driving behavior score 111 may be shown to the customer on a trip level or daily level, after the driving behavior coach 103 collects enough data to give a confident potential fuel savings estimation. In some embodiments, the prediction confidence interval may also be provided the user (for example, a fleet manager) to provide more information about the fuel saving potentials.

In block 707, the driving behavior score 111 that was determined in block 705 is provided to the user via user interface device 112. In some embodiments, the driving behavior score 111 is provided to the user based on the prediction confidence interval that was determined in block 706 being above a predetermined confidence threshold. In some embodiments, the user may receive a plurality of different driving behavior scores associated with driving data from different trips, different vehicles, and/or different drivers.

### EXAMPLES

In some instances, the following examples may be implemented together or separately by the systems and methods described herein.

Example 1 may include a non-transitory computer-readable medium storing computer-executable instructions which, when executed by a processor, cause the processor to perform operations comprising: obtaining driving data of a vehicle during operation of the vehicle, the driving data including braking data and acceleration data; identifying, based on the braking data, a braking event during a first time period, wherein the braking event exceeds a braking threshold; generating, based on the braking event, first coached driving data; determining, based on the first coached driving data, a first fuel savings; identifying, based on the acceleration data, an acceleration event during a second time period, wherein the acceleration event exceeds an acceleration threshold; generating, based on the acceleration event, second coached driving data; determining, based on the second coached driving data, a second fuel savings; determining, based on the first fuel savings and the second fuel savings, a total fuel savings; and generating, based on the total fuel savings, a driving behavior score.

Example 2 may include the non-transitory computer-readable medium of example 1, wherein generating the first coached driving data comprises: determining, based on adding an additional amount of time to the first time period, a coached braking time period; determining, based on a vehicle response model, an engine speed and a torque of the vehicle over the coached braking time period; and determining, based on the engine speed and the torque of the vehicle over the coached braking time period, the first fuel savings.

Example 3 may include the non-transitory computer-readable medium of example 1, wherein generating the second coached driving data comprises: determining a distance between a position of the vehicle at a start of the second time period and a position of the vehicle at a time after an end of the second time period; determining, based on the distance, a coached acceleration time period; determining, based on a vehicle response model, an engine speed and a torque of the vehicle over the coached acceleration time period; and determining, based on the engine speed and torque of the vehicle over the coached acceleration time period, the second fuel savings.

Example 4 may include the non-transitory computer-readable medium of example 1, wherein the vehicle comprises a manual transmission vehicle, and wherein the computer-executable instructions cause the processor to perform further operations, comprising: determining, from the driving data, a first gear number, a first engine speed, a first torque, a first vehicle speed, and a first acceleration corresponding to a third time period; determining, based on a vehicle response model, for a second gear number adjacent to the first gear number, that a torque demand corresponding to the first vehicle speed and the first acceleration can be met within a time after shifting to the second gear; determining, based on determining that the torque demand corresponding to the first vehicle speed and the first acceleration can be met within the time after shifting to the second gear, a shifting event to the second gear; determining, based on the shifting event to the second gear, a third fuel savings; and determining, based on the first fuel savings, the second fuel savings, and the third fuel savings, the total fuel savings.

Example 5 may include the non-transitory computer-readable medium of example 1, wherein the computer-executable instructions cause the processor to perform further operations, comprising: determining engine speed data, torque data, and fuel consumption data from the vehicle during operation of the vehicle; constructing, based on the engine speed data, torque data, and fuel consumption data, a fuel consumption model for the vehicle; and determining, based on the fuel consumption model, the first fuel savings and the second fuel savings.

Example 6 may include the non-transitory computer-readable medium of example 1, wherein the computer-executable instructions cause the processor to perform further operations, comprising: determining a prediction confidence interval for the driving behavior score; and causing, based on the prediction confidence interval being above a confidence threshold, the driving behavior score to be provided to a user.

Example 7 may include a computer-implemented method comprising: obtaining driving data of a vehicle during operation of the vehicle, the driving data including braking data and acceleration data; identifying, based on the braking data, a braking event during a first time period, wherein the braking event exceeds a braking threshold; generating, based on the braking event, first coached driving data; determining, based on the first coached driving data, a first fuel savings; identifying, based on the acceleration data, an acceleration event during a second time period, wherein the acceleration event exceeds an acceleration threshold; generating, based on the acceleration event, second coached driving data; determining, based on the second coached driving data, a second fuel savings; determining, based on the first fuel savings and the second fuel savings, a total fuel savings; and generating, based on the total fuel savings, a driving behavior score.

Example 8 may include the computer-implemented method of example 7, wherein generating the first coached driving data comprises: determining, based on adding an additional amount of time to the first time period, a coached braking time period; determining, based on a vehicle response model, an engine speed and a torque of the vehicle over the coached braking time period; and determining, based on the engine speed and the torque of the vehicle over the coached braking time period, the first fuel savings.

Example 9 may include the computer-implemented method of example 7, wherein generating the second coached driving data comprises: determining a distance between a position of the vehicle at a start of the second time period and a position of the vehicle at a time after an end of the second time period; determining, based on the distance, a coached acceleration time period; determining, based on a vehicle response model, an engine speed and a torque of the vehicle over the coached acceleration time period; and determining, based on the engine speed and torque of the vehicle over the coached acceleration time period, the second fuel savings.

Example 10 may include the computer-implemented method of example 7, wherein the vehicle comprises a manual transmission vehicle, and further comprising: determining, from the driving data, a first gear number, a first engine speed, a first torque, a first vehicle speed, and a first acceleration corresponding to a third time period; determining, based on a vehicle response model, for a second gear number adjacent to the first gear number, that a torque demand corresponding to the first vehicle speed and the first acceleration can be met within a time after shifting to the second gear; determining, based on determining that the torque demand corresponding to the first vehicle speed and the first acceleration can be met within the time after shifting to the second gear, a shifting event to the second gear; determining, based on the shifting event to the second gear, a third fuel savings; and determining, based on the first fuel savings, the second fuel savings, and the third fuel savings, the total fuel savings.

Example 11 may include the computer-implemented method of example 10, wherein the braking event is determined before the shifting event, and the shifting event is determined before the acceleration event; and wherein the first time period, the second time period, and the third time period do not overlap.

Example 12 may include the computer-implemented method of example 7, further comprising: determining engine speed data, torque data, and fuel consumption data from the vehicle during operation of the vehicle; constructing, based on the engine speed data, torque data, and fuel consumption data, a fuel consumption model for the vehicle; and determining, based on the fuel consumption model, the first fuel savings and the second fuel savings.

Example 13 may include the computer-implemented method of example 7, wherein the computer-executable instructions cause the processor to perform further operations, comprising: determining a prediction confidence interval for the driving behavior score; and causing, based on the prediction confidence interval being above a confidence threshold, the driving behavior score to be provided to a user.

Example 14 may include the computer-implemented method of example 7, wherein the braking event is determined before the acceleration event, and the first time period and the second time period do not overlap.

Example 15 may include a system comprising: at least one memory storing computer-executable instructions; and at least one processor, wherein the at least one processor is configured to access the at least one memory and to execute the computer-executable instructions to: obtain driving data of a vehicle during operation of the vehicle, the driving data including braking data and acceleration data; identify, based on the braking data, a braking event during a first time period, wherein the braking event exceeds a braking threshold; generate, based on the braking event, first coached driving data; determine, based on the first coached driving data, a first fuel savings; identify, based on the acceleration data, an acceleration event during a second time period, wherein the acceleration event exceeds an acceleration threshold; generate, based on the acceleration event, second coached driving data; determine, based on the second coached driving data, a second fuel savings; determine, based on the first fuel savings and the second fuel savings, a total fuel savings; and generate, based on the total fuel savings, a driving behavior score.

Example 16 may include the system of example 15, wherein generating the first coached driving data comprises: determining, based on adding an additional amount of time to the first time period, a coached braking time period; determining, based on a vehicle response model, an engine speed and a torque of the vehicle over the coached braking time period; and determining, based on the engine speed and the torque of the vehicle over the coached braking time period, the first fuel savings.

Example 17 may include the system of example 15, wherein generating the second coached driving data comprises: determining a distance between a position of the vehicle at a start of the second time period and a position of the vehicle at a time after an end of the second time period; determining, based on the distance, a coached acceleration time period; determining, based on a vehicle response model, an engine speed and a torque of the vehicle over the coached acceleration time period; and determining, based on the engine speed and torque of the vehicle over the coached acceleration time period, the second fuel savings.

Example 18 may include the system of example 15, wherein the vehicle comprises a manual transmission vehicle, and wherein the at least one processor is configured to access the at least one memory and to further execute the computer-executable instructions, comprising: determining, from the driving data, a first gear number, a first engine speed, a first torque, a first vehicle speed, and a first acceleration corresponding to a third time period; determining, based on a vehicle response model, for a second gear number adjacent to the first gear number, that a torque demand corresponding to the first vehicle speed and the first acceleration can be met within a time after shifting to the second gear; determining, based on determining that the torque demand corresponding to the first vehicle speed and the first acceleration can be met within the time after shifting to the second gear, a shifting event to the second gear; determining, based on the shifting event to the second gear, a third fuel savings; and determining, based on the first fuel savings, the second fuel savings, and the third fuel savings, the total fuel savings.

Example 19 may include the system of example 15, wherein the at least one processor is configured to access the at least one memory and to further execute the computer-executable instructions, comprising: determining engine speed data, torque data, and fuel consumption data from the vehicle during operation of the vehicle; constructing, based on the engine speed data, torque data, and fuel consumption data, a fuel consumption model for the vehicle; and determining, based on the fuel consumption model, the first fuel savings and the second fuel savings.

Example 20 may include the system of example 15, wherein the at least one processor is configured to access the at least one memory and to further execute the computer-executable instructions, comprising: determining a prediction confidence interval for the driving behavior score; and causing, based on the prediction confidence interval being above a confidence threshold, the driving behavior score to be provided to a user.

### CONCLUSION

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, can be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that can direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a non-transitory computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A non-transitory computer-readable medium storing computer-executable instructions which, when executed by a processor, cause the processor to perform operations comprising:
obtaining driving data of a vehicle during operation of the vehicle, the driving data including braking data and acceleration data;
identifying, based on the braking data, a braking event during a first time period, wherein the braking event exceeds a braking threshold;
generating, based on the braking event, first coached driving data;
determining, based on the first coached driving data, a first fuel savings;
identifying, based on the acceleration data, an acceleration event during a second time period, wherein the acceleration event exceeds an acceleration threshold;
generating, based on the acceleration event, second coached driving data;
determining, based on the second coached driving data, a second fuel savings;
determining, based on the first fuel savings and the second fuel savings, a total fuel savings; and
generating, based on the total fuel savings, a driving behavior score.

2. The non-transitory computer-readable medium of claim 1, wherein generating the first coached driving data comprises:
determining, based on adding an additional amount of time to the first time period, a coached braking time period;
determining, based on a vehicle response model, an engine speed and a torque of the vehicle over the coached braking time period; and
determining, based on the engine speed and the torque of the vehicle over the coached braking time period, the first fuel savings.

3. The non-transitory computer-readable medium of claim 1, wherein generating the second coached driving data comprises:
determining a distance between a position of the vehicle at a start of the second time period and a position of the vehicle at a time after an end of the second time period;
determining, based on the distance, a coached acceleration time period;
determining, based on a vehicle response model, an engine speed and a torque of the vehicle over the coached acceleration time period; and
determining, based on the engine speed and torque of the vehicle over the coached acceleration time period, the second fuel savings.

4. The non-transitory computer-readable medium of claim 1, wherein the vehicle comprises a manual transmission vehicle, and wherein the computer-executable instructions cause the processor to perform further operations, comprising:
determining, from the driving data, a first gear number, a first engine speed, a first torque, a first vehicle speed, and a first acceleration corresponding to a third time period;
determining, based on a vehicle response model, for a second gear number adjacent to the first gear number, that a torque demand corresponding to the first vehicle speed and the first acceleration can be met within a time after shifting to the second gear;
determining, based on determining that the torque demand corresponding to the first vehicle speed and the first acceleration can be met within the time after shifting to the second gear, a shifting event to the second gear;
determining, based on the shifting event to the second gear, a third fuel savings; and
determining, based on the first fuel savings, the second fuel savings, and the third fuel savings, the total fuel savings.

5. The non-transitory computer-readable medium of claim 1, wherein the computer-executable instructions cause the processor to perform further operations, comprising:
determining engine speed data, torque data, and fuel consumption data from the vehicle during operation of the vehicle;
constructing, based on the engine speed data, torque data, and fuel consumption data, a fuel consumption model for the vehicle; and
determining, based on the fuel consumption model, the first fuel savings and the second fuel savings.

6. The non-transitory computer-readable medium of claim 1, wherein the computer-executable instructions cause the processor to perform further operations, comprising:
determining a prediction confidence interval for the driving behavior score; and
causing, based on the prediction confidence interval being above a confidence threshold, the driving behavior score to be provided to a user.

7. A computer-implemented method comprising:
obtaining driving data of a vehicle during operation of the vehicle, the driving data including braking data and acceleration data;
identifying, based on the braking data, a braking event during a first time period, wherein the braking event exceeds a braking threshold;
generating, based on the braking event, first coached driving data;
determining, based on the first coached driving data, a first fuel savings;
identifying, based on the acceleration data, an acceleration event during a second time period, wherein the acceleration event exceeds an acceleration threshold;
generating, based on the acceleration event, second coached driving data;
determining, based on the second coached driving data, a second fuel savings;
determining, based on the first fuel savings and the second fuel savings, a total fuel savings; and
generating, based on the total fuel savings, a driving behavior score.

8. The computer-implemented method of claim 7, wherein generating the first coached driving data comprises:
determining, based on adding an additional amount of time to the first time period, a coached braking time period;
determining, based on a vehicle response model, an engine speed and a torque of the vehicle over the coached braking time period; and
determining, based on the engine speed and the torque of the vehicle over the coached braking time period, the first fuel savings.

9. The computer-implemented method of claim 7, wherein generating the second coached driving data comprises:
determining a distance between a position of the vehicle at a start of the second time period and a position of the vehicle at a time after an end of the second time period;
determining, based on the distance, a coached acceleration time period;
determining, based on a vehicle response model, an engine speed and a torque of the vehicle over the coached acceleration time period; and
determining, based on the engine speed and torque of the vehicle over the coached acceleration time period, the second fuel savings.

10. The computer-implemented method of claim 7, wherein the vehicle comprises a manual transmission vehicle, and further comprising:
determining, from the driving data, a first gear number, a first engine speed, a first torque, a first vehicle speed, and a first acceleration corresponding to a third time period;
determining, based on a vehicle response model, for a second gear number adjacent to the first gear number, that a torque demand corresponding to the first vehicle speed and the first acceleration can be met within a time after shifting to the second gear;
determining, based on determining that the torque demand corresponding to the first vehicle speed and the first acceleration can be met within the time after shifting to the second gear, a shifting event to the second gear;
determining, based on the shifting event to the second gear, a third fuel savings; and
determining, based on the first fuel savings, the second fuel savings, and the third fuel savings, the total fuel savings.

11. The computer-implemented method of claim 10, wherein the braking event is determined before the shifting event, and the shifting event is determined before the acceleration event; and
wherein the first time period, the second time period, and the third time period do not overlap.

12. The computer-implemented method of claim 7, further comprising:
determining engine speed data, torque data, and fuel consumption data from the vehicle during operation of the vehicle;
constructing, based on the engine speed data, torque data, and fuel consumption data, a fuel consumption model for the vehicle; and
determining, based on the fuel consumption model, the first fuel savings and the second fuel savings.

13. The computer-implemented method of claim 7, wherein the computer-executable instructions cause the processor to perform further operations, comprising:
determining a prediction confidence interval for the driving behavior score; and
causing, based on the prediction confidence interval being above a confidence threshold, the driving behavior score to be provided to a user.

14. The computer-implemented method of claim 7, wherein the braking event is determined before the acceleration event, and the first time period and the second time period do not overlap.

15. A system comprising:
at least one memory storing computer-executable instructions; and
at least one processor, wherein the at least one processor is configured to access the at least one memory and to execute the computer-executable instructions to:
obtain driving data of a vehicle during operation of the vehicle, the driving data including braking data and acceleration data;
identify, based on the braking data, a braking event during a first time period, wherein the braking event exceeds a braking threshold;
generate, based on the braking event, first coached driving data;
determine, based on the first coached driving data, a first fuel savings;
identify, based on the acceleration data, an acceleration event during a second time period, wherein the acceleration event exceeds an acceleration threshold;
generate, based on the acceleration event, second coached driving data;
determine, based on the second coached driving data, a second fuel savings;
determine, based on the first fuel savings and the second fuel savings, a total fuel savings; and
generate, based on the total fuel savings, a driving behavior score.

16. The system of claim 15, wherein generating the first coached driving data comprises:
determining, based on adding an additional amount of time to the first time period, a coached braking time period;
determining, based on a vehicle response model, an engine speed and a torque of the vehicle over the coached braking time period; and
determining, based on the engine speed and the torque of the vehicle over the coached braking time period, the first fuel savings.

17. The system of claim 15, wherein generating the second coached driving data comprises:
determining a distance between a position of the vehicle at a start of the second time period and a position of the vehicle at a time after an end of the second time period;
determining, based on the distance, a coached acceleration time period;
determining, based on a vehicle response model, an engine speed and a torque of the vehicle over the coached acceleration time period; and
determining, based on the engine speed and torque of the vehicle over the coached acceleration time period, the second fuel savings.

18. The system of claim 15, wherein the vehicle comprises a manual transmission vehicle, and wherein the at least one processor is configured to access the at least one memory and to further execute the computer-executable instructions, comprising:
determining, from the driving data, a first gear number, a first engine speed, a first torque, a first vehicle speed, and a first acceleration corresponding to a third time period;
determining, based on a vehicle response model, for a second gear number adjacent to the first gear number, that a torque demand corresponding to the first vehicle speed and the first acceleration can be met within a time after shifting to the second gear;
determining, based on determining that the torque demand corresponding to the first vehicle speed and the first acceleration can be met within the time after shifting to the second gear, a shifting event to the second gear;
determining, based on the shifting event to the second gear, a third fuel savings; and
determining, based on the first fuel savings, the second fuel savings, and the third fuel savings, the total fuel savings.

19. The system of claim 15, wherein the at least one processor is configured to access the at least one memory and to further execute the computer-executable instructions, comprising:
determining engine speed data, torque data, and fuel consumption data from the vehicle during operation of the vehicle;
constructing, based on the engine speed data, torque data, and fuel consumption data, a fuel consumption model for the vehicle; and
determining, based on the fuel consumption model, the first fuel savings and the second fuel savings.

20. The system of claim 15, wherein the at least one processor is configured to access the at least one memory and to further execute the computer-executable instructions, comprising:
determining a prediction confidence interval for the driving behavior score; and
causing, based on the prediction confidence interval being above a confidence threshold, the driving behavior score to be provided to a user.
